(19) United States
(12) Patent Application Publication
(10) Pub. No.: US 2002/0108701 A1
(43) Pub. Date: Aug. 15, 2002

(54) Method of producing a filter insert

(76) Inventors: Dieter Hintenlang, Abtsteinach (DE); Dieter Unrath, Weinheim (DE); Hans Wiegand, Furth (DE)

Correspondence Address: KENYON & KENYON, ONE BROADWAY, NEW YORK, NY, 10004, US

(21) Appl. No.: 10/013,123

(22) Filed: Dec. 7, 2001

(30) Foreign Application Priority Data
Dec. 8, 2000 (DE) 100 61 479.5

(51) Int. Cl. B31F 1/00

(52) U.S. Cl. 156/205; 156/196

(57) ABSTRACT

A method of producing a filter insert (1) having folds (2) extending radially, by first pleating a filter material to form an essentially rectangular filter sheet (3) having folds (2) arranged across the longitudinal direction (4), then wrapping the pleated filter sheet (3) around a core (7), and next joining the first fold (8) and last fold (9) of the filter sheet (3) adjacent to one another in the circumferential direction.

### BACKGROUND OF THE INVENTION

1. Field of the Invention

The present invention relates to a method of producing an essentially annular filter insert.

2. Description of Related Art

Annular filter inserts are known in general, as are the methods for producing them. The previously known annular filter inserts are made of an open-cell foam, for example, circles being punched from a flat foam body. However, it should be pointed out here that the punch method generates a great deal of waste in the form of cuttings between the circles punched out. This is not very satisfactory from an economic standpoint.

Unexamined German Patent 28 42 127 describes a filter insert having folds extending radially.

### SUMMARY OF THE INVENTION

It is an object the invention to provide a method of producing an essentially annular filter insert which can be carried out easily and economically.

These and other objects of the invention are achieved by a method of producing a filter insert having folds extending radially, by first pleating a filter material to form an essentially rectangular filter sheet having folds arranged across the longitudinal direction, then wrapping the pleated filter sheet around a core, and next joining the first and last fold of the filter sheet adjacent to one another in the circumferential direction.

### BRIEF DESCRIPTION OF THE DRAWINGS

The present invention will be described in greater detail with reference to the following drawings wherein:

FIG. 1 shows the rectangular filter sheet according to the first step of the method and the section line along which the filter sheet is cut according to the second step of the method.

FIG. 2 shows one of the partial filter sheets wrapped around a core according to the third step of the method.

FIG. 3 shows the ready-to-use annular filter insert obtained after the fourth step of the method.

### DETAILED DESCRIPTION OF THE INVENTION

In accordance with a preferred embodiment of the invention, there is provided a method of producing a filter insert having folds extending radially, a filter material being pleated to form an essentially rectangular filter sheet having folds arranged across the longitudinal direction in a first method step, the filter sheet being cut at least once in the longitudinal direction in a second method step to obtain at least two partial filter sheets, each partial filter sheet being wrapped around a core in a third method step, and the first and last fold of each partial filter sheet adjacent to one another in the circumferential direction being joined together in a fourth method step. It is advantageous here that it is especially simple to produce the annular filter insert having folds extending radially. There is no waste in production of the filter insert, because there is no cutting in the method according to the present invention. It is also advantageous that a rectangular filter sheet having folds pleated across the longitudinal direction forms the basis of at least two filter inserts. Cutting the filter sheet longitudinally in the second step of the method can be accomplished more quickly than pleating another rectangular filter sheet, so that with regard to the fastest possible production of the largest possible number of such filter inserts, it is always more advantageous to cut the filter sheet longitudinally according to the second step of the method than to produce another suitably dimensioned rectangular filter sheet according to the first step of the method. The joining of the first and last fold of each partial filter sheet adjacent to one another in the circumferential direction can be accomplished, for example, by gluing or welding the first and last fold together. Due to the folds extending radially, the filter insert produced by the method claimed here has a large filter area in comparison with filter inserts made of foam. This yields a good filtration result during a long service life.

The core may be foamed and may be made of polyurethane, for example. In general, there is the possibility of foaming the core onto the radially adjacent end faces of the folds in a flow-proof manner. The core and the radially adjacent end faces of the folds are preferably joined together in a flow-proof manner. The core and the radially inside end faces of the folds may be joined together in a form-fitting or frictional connection.

The core about which a partial filter sheet is wrapped may be formed by a solid cylinder or a hollow cylinder, for example. The core is preferably made of a polymer material. Therefore, the filter insert on the whole has a low weight and is free of rust, so the filter insert can even be used in a high atmospheric humidity without any drawbacks.

For applications demanding a high purity of the filtered medium, it may be advantageous, for example, if the core is made of a closed-cell foam and the radially adjacent end faces of the folds are contacted under elastic bias with a sealing effect. Therefore, there is no need for any separate seal and/or fastening in this area.

Production of the filter insert can be simplified in that one longitudinal side of the filter sheet and/or of the partial filter sheets is joined with one edge in a flow-proof manner. The edge encloses the ready-to-use filter insert on the outside peripherally and can be applied to the end face of the filter sheet by the essentially known edge gluing technique, for example, or by ultrasonic welding.

It is especially advantageous if both longitudinal sides of the filter sheet are joined with one edge in a flow-proof manner following the first step of the method before cutting the filter sheet longitudinally in the second step of the method. It is advantageous here that after cutting longitudinally in the second step of the method, the two partial filter sheets are each joined on one end with the edge which later forms the outer circumference of the ready-to-use filter insert. However, the sides of the partial filter sheets facing the joint form the inside circumference of the annular filter insert, are turned toward the core and are connected to it in a flow-proof connection if necessary.

The core can be sheathed with a sealing material on the outer circumference before the third step of the method, where a closed-cell foam may be sprayed or glued on as the sealing material to form the sheathing, for example. Sheathing the core is advantageous if the folds are required to contact the core radially on the inside and seal it to achieve an improved filter effect.

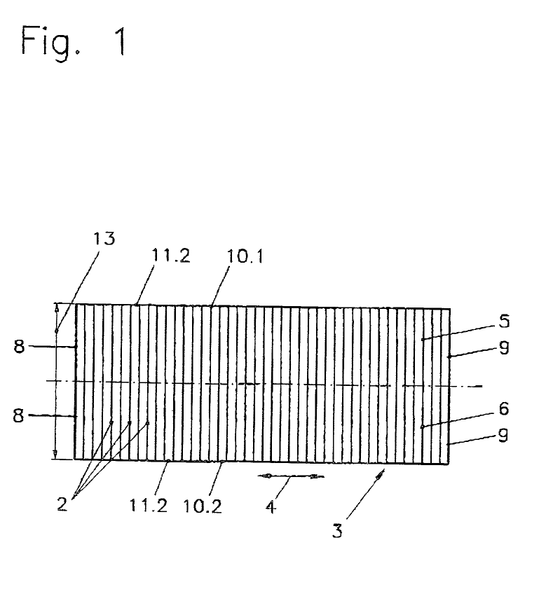

FIG. 1 shows a rectangular filter sheet 3, folds 2 arranged across longitudinal direction 4 being produced by pleating in the first step of the method.

In this embodiment, width 13 of filter sheet 3 corresponds essentially to twice the width of ready-to-use annular filter insert 1, so that two partial filter sheets 5, 6 can be produced from filter sheet 3 shown here, later being joined to form annular filter insert 1.

Before filter sheet 3 is cut in longitudinal direction 4 in the second step of the method to obtain two partial filter sheets 5, 6, one edge is applied in a flow-proof manner to each of two longitudinal sides 10.1, 10.2 of filter sheet 3 after pleating. Edges 11.1, 11.2 form the outer circumference of the ready-to-use annular filter insert and seal it with respect to a filter casing.

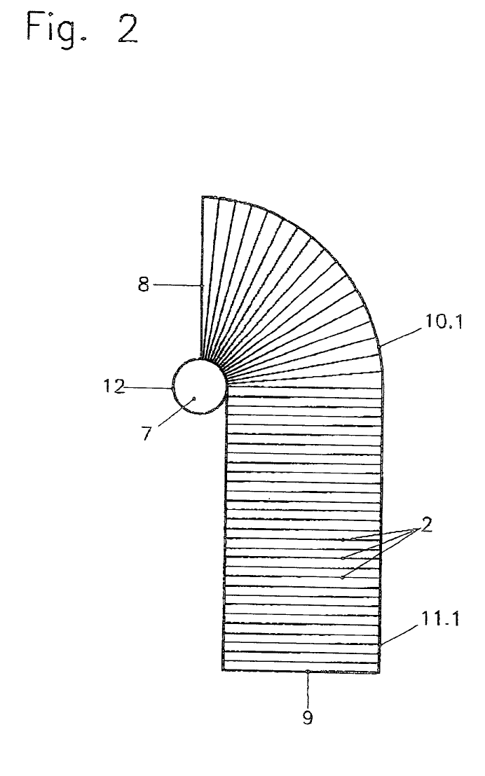

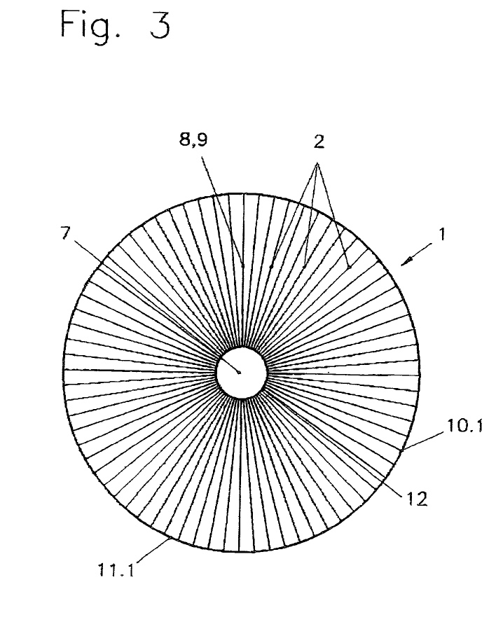

After filter sheet 3 was cut in longitudinal direction 4 in the second step of the method, thus forming two partial filter sheets 5, 6, these sheets are wrapped around core 7 in the third step of the method as shown in FIG. 2. Partial filter sheets 5, 6 completely surround core 7, as shown in FIG. 3, first fold 8 and last fold 9 of respective partial filter sheets 5, 6 being joined together in the fourth step of the method. They are joined by gluing or welding, for example.

In this embodiment, core 7 is sheathed with a sealing material on the outer circumference, this sealing material being formed by a closed-cell foam, for example. The inner longitudinal side of partial filter sheets 5, 6 contacts sealing material 12 to prevent a flow short circuit between the incoming flow side and the outgoing flow side.

What is claimed is:

1. A method of producing a filter insert (1) having folds (2) extending radially, comprising: first pleating a filter material to form an essentially rectangular filter sheet (3) having folds (2) arranged across the longitudinal direction (4), then wrapping the pleated filter sheet (3) around a core (7), and next joining the first (8) and last fold (9) of the filter sheet (3) adjacent to one another in the circumferential direction.

2. The method according to claim 1, wherein one longitudinal side (10) of the filter sheet (3) or one longitudinal side of the partial filter sheets (5, 6) are joined with one edge (11) in a flow-proof manner.

3. The method according to claim 2, wherein both longitudinal sides (10.1, 10.2) of the filter sheet (3) are joined each with one edge (11.1, 11.2) in a flow-proof manner following the first step.

4. The method according to claim 1, wherein the core (7) is sheathed with a sealing material (12) on the outer circumference.

5. The method according to claim 2, wherein the core (7) is sheathed with a sealing material (12) on the outer circumference.

6. The method according to claim 3, wherein the core (7) is sheathed with a sealing material (12) on the outer circumference.

7. The method according to claim 4, wherein a closed-cell foam is sprayed on as the sealing material (12).

8. The method according to claim 1, wherein the core (7) and the radially adjacent end faces of the folds (2) are joined in a flow-proof manner.

9. The method according to claim 1, wherein the core (7) is foamed onto the radially inside end faces of the folds (2) in a flow-proof manner.

10. The method according to claim 1, wherein the core (7) and the radially inside end faces of the folds (2) are joined in a frictional or form-fitting connection.

11. A method of producing a filter insert (1) having folds (2) extending radially, comprising: pleating a filter material to form an essentially rectangular filter sheet (3) having folds (2) arranged across the longitudinal direction (4) in a first step, cutting the filter sheet (3) at least once in the longitudinal direction (4) in a second step to obtain at least two partial filter sheets (5, 6), wrapping each partial filter sheet (5, 6) around a core (7) in a third step, and joining the first (8) and last fold (9) of each partial filter sheet (5, 6) adjacent to one another in the circumferential direction together in a fourth step.

12. The method according to claim 11, wherein one longitudinal side (10) of the filter sheet (3) or one longitudinal side of the partial filter sheets (5, 6) are joined with one edge (11) in a flow-proof manner.

13. The method according to claim 12, wherein both longitudinal sides (10.1, 10.2) of the filter sheet (3) are joined each with one edge (11.1, 11.2) in a flow-proof manner following the first step.

14. The method according to claim 11, wherein the core (7) is sheathed with a sealing material (12) on the outer circumference.

15. The method according to claim 12, wherein the core (7) is sheathed with a sealing material (12) on the outer circumference.

16. The method according to claim 13, wherein the core (7) is sheathed with a sealing material (12) on the outer circumference.

17. The method according to claim 14, wherein a closed-cell foam is sprayed on as the sealing material (12).

18. The method according to claim 11, wherein the core (7) and the radially adjacent end faces of the folds (2) are joined in a flow-proof manner.

19. The method according to claim 11, wherein the core (7) is foamed onto the radially inside end faces of the folds (2) in a flow-proof manner.

20. The method according to claim 11, wherein the core (7) and the radially inside end faces of the folds (2) are joined in a frictional and/or form-fitting connection.
